(19) United States
(12) Patent Application Publication
(10) Pub. No.: US 2017/0275971 A1
(43) Pub. Date: Sep. 28, 2017

(54) A METHOD AND A SYSTEM FOR EXTRACTING FLUIDS

(71) Applicant: RELIANCE INDUSTRIES LIMITED, Mumbai, Maharashtra (IN)

(72) Inventors: Timmie Dale SHEDD, Mumbai, Maharashtra (IN); Rama Krishna Rao DONTHULA, Hyderabad, Telangana (IN); Satish Kumar PANDEY, Gopalganj, Bihar (IN)

(73) Assignee: RELIANCE INDUSTRIES LIMITED, Mumbai, Maharashtra (IN)

(21) Appl. No.: 15/518,562

(22) PCT Filed: Oct. 14, 2015
(86) PCT No.: PCT/IB2015/057853

§ 371 Date: Apr. 12, 2017

(30) Foreign Application Priority Data
Oct. 14, 2014 (IN) 3277/MUM/2014

(51) Int. Cl. E21B 43/00; C09K 8/38; B01D 19/04; C09K 8/18

(52) U.S. Cl. CPC E21B 43/00; C09K 8/18; C09K 8/38; B01D 19/04

(57) ABSTRACT

The present disclosure relates to a method and a system for extracting fluids comprising natural gas and water from a reservoir via at least one oil well/gas well connected to at least one flow line network. For extracting fluids, a composition containing a foaming composition is injected at a pre-determined location into the oil well/gas well and/or the flow line network. The foaming composition is then agitated with the water and converted to foam. The agitation is carried out by the natural gas. The foam formed reduces the interfacial surface tension between the natural gas and the water, and thereby facilitates reduction in liquid holdup in the oil well/gas well and/or the flow line network. The system of the present disclosure includes at least one manifold, at least one distribution assembly and a plurality of control valves and sensors.

### FIELD

The present disclosure relates to a method and a system for extracting fluids from oil wells/gas wells. In particular, the present disclosure relates to a method and a system for extracting hydrocarbons from the oil wells/gas wells.

### DEFINITIONS

As used in the present disclosure, the following words and phrases are generally intended to have the meaning as set forth below, except to the extent that the context in which they are used to indicate otherwise.

Backpressure—refers to a pressure within a system, which includes flowline networks, oil wells, gas wells and sandface, caused by fluid friction, gravitation or an induced resistance to flow through the system;

Critical velocity—refers to a velocity that a fluid attains when the gravity and the backpressure equalize on the available pressure of the fluid;

Reservoir—refers to a subsurface body of rock having sufficient porosity and permeability to store and transmit fluids;

Liquid holdup—refers to a cross sectional area of a pipeline occupied by the liquid in the pipe carrying the wet gas; and

MMSCD—refers to million metric standard cubic meter per day.

### BACKGROUND

In order to meet the increasing fuel demand, many oil producers have concentrated their efforts to extract fuels from oil wells/gas wells.

Oil wells/gas wells are drilled in a reservoir, which may be on land or underwater. The fluids extracted from these wells include natural gas and water.

During the initial stages when the oil wells/gas wells are drilled, the pressure of the fluids in the reservoir is adequate to facilitate the flow of fluids from the reservoir to the oil wells/gas wells and/or flow line networks connected to the oil wells/gas wells, thereby facilitating extraction of the fluids from the oil wells/gas wells.

However, with time, extraction of the water increases, extraction of hydrocarbon fluids decreases and the pressures in the reservoir deplete, which results in the decreased flow rate of the hydrocarbon fluids. Due to this, the liquid holdup in the oil wells/gas wells and/or the flow line networks increases. The increased liquid hold-up in the oil wells/gas wells results in an increased backpressure on the sandface, thereby inhibiting the flow of the hydrocarbon fluids from the reservoir. Due to the reduced flow rate of the hydrocarbon fluids, liquid hold-up further increases, thereby causing further increase in the back pressure. Further, due to the increased backpressure, the fluids flow at a critical velocity (that increases with increasing the back pressure) from the reservoir to the oil wells/gas wells, thereby reducing extraction of the fluids from the oil wells/gas wells.

Also, the increased liquid holdup in the flow line networks can cause additional backpressure in the oil wells/gas wells, thereby decreasing extraction of the hydrocarbon fluids from the oil wells/gas wells. Moreover, the additional backpressure exerted in the oil wells/gas wells affects the synergy (pressure balance) between the flow line networks, the oil wells/gas wells and the reservoir, thereby affecting the extraction of the hydrocarbon fluids from the oil wells/gas wells.

Therefore, in order to extract the hydrocarbon fluids from the oil wells/gas wells efficiently, it is necessary to reduce:
the backpressure on the sandface; and
the additional backpressure in the flow line networks.

Thus, there is felt a need for a method and a system for extracting fluids from a reservoir via oil wells/gas wells and to overcome the above mentioned drawbacks.

### OBJECTS

Some of the objects of the present disclosure, which at least one embodiment herein satisfies, are as follows.

It is an object of the present disclosure to ameliorate one or more problems of the prior art or to at least provide a useful alternative.

An object of the present disclosure is to extract fluids from oil wells/gas wells.

Another object of the present disclosure is to extract fluids from oil wells/gas wells for longer duration.

Yet another object of the present disclosure is to reduce liquid holdup in oil wells/gas wells and/or flow line networks.

Still another object of the present disclosure is to reduce backpressure on a sandface.

Yet another object of the present disclosure is to reduce backpressure in flow line networks

Other objects and advantages of the present disclosure will be more apparent from the following description, which is not intended to limit the scope of the present disclosure.

### SUMMARY

The present disclosure envisages a method and a system for extracting fluids comprising natural gas and water from a reservoir via at least one oil well/gas well connected to at least one flow line network. The method of the present disclosure is carried out by injecting a composition containing a foaming composition in an amount in the range of 1 to 30% (mass/mass) of the total liquid at a pre-determined location into the oil well/gas well and/or the flow line network. The foaming composition is then agitated with the water and converted to foam. The foam formed reduces the interfacial surface tension between the natural gas and the water flowing through the oil well and/or the flow line network, and thereby facilitates reduction in liquid holdup in the oil well/gas well and/or the flow line network.

In accordance with the present disclosure, the agitation of the foaming composition with the water is carried out by the flow of the natural gas being extracted from the reservoir via the oil well/gas well connected to the flow line network.

In accordance with the present disclosure, the composition includes injecting a de-foaming agent in an amount in the range of 0.1 to 0.2% (mass/mass) of the total liquid, into the oil well/gas well and/or the flow line network.

### BRIEF DESCRIPTION OF ACCOMPANYING DRAWING

A method and a system for extracting fluids from a reservoir via at least one oil well/gas well connected to at least one flow line network in accordance with the present disclosure will now be described with the help of the accompanying drawing, in which:

FIG. 1 illustrates a flow chart depicting a system for extracting fluids from oil wells/gas wells connected to flow line networks in accordance with the present disclosure.

### DETAILED DESCRIPTION

The disclosure will now be described with reference to the accompanying embodiments which do not limit the scope and ambit of the disclosure. The description provided is purely by way of example and illustration.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Oil wells/gas wells are drilled in reservoirs to extract fluids from the reservoirs. Typically, the fluids in the reservoir include crude oil, hydrocarbon condensates, natural gas and water.

During the initial stages when the oil wells/gas wells are drilled, the pressure of the fluids in the reservoir is adequate to facilitate the flow of the fluids from the reservoir to the oil wells/gas wells and/or flow line networks connected to the oil wells/gas wells, that facilitates extraction of the fluids from the oil wells/gas wells.

However, with time, extraction of the water increases, extraction of the hydrocarbon fluids (particularly natural gas) decreases and the pressures in the reservoir deplete, thereby decreasing the flow rate of the fluids. Due to this, the liquid holdup in the oil wells/gas wells and/or the flow line networks increases. The increased liquid hold-up results in:
an increased backpressure on the sandface, thereby inhibiting the flow of the hydrocarbon fluids from the reservoir; and
an additional backpressure in the oil wells/gas wells, thereby decreasing the extraction of the hydrocarbon fluids from the oil wells/gas wells. The backpressure exerted in the oil wells/gas wells affects the synergy (pressure balance) between the flow line networks, the oil wells and the reservoir, thereby affecting the extraction of the hydrocarbon fluids from the oil wells/gas wells.

The present disclosure, therefore, provides a method and a system for extracting fluids from the reservoir via the oil wells/gas wells connected to the flow line networks, by reducing the liquid hold-up in the oil wells/gas wells and/or the flow line networks.

In accordance with the present disclosure, there is provided a method and a system for extracting the fluids comprising natural gas and water from a reservoir via at least one oil well/gas well connected to at least one flow line network.

The method of the present disclosure is carried out in the following steps:
in the first step, a composition containing a foaming composition is injected into the oil well/gas well and/or the flow line network at a pre-determined location; and
in the second step, the foaming composition is agitated with the water and some portion of the water is converted to foam, thereby reducing the interfacial surface tension between the natural gas and the water flowing through the oil well/gas well and/or the flow line network, and thereby facilitating a reduction in liquid holdup in the oil well/gas well and/or the flow line network.

In accordance with the present disclosure, the foaming composition is agitated with the water by the natural gas being extracted from the reservoir via the oil well/gas well connected to the flow line network.

Reduction in the liquid holdup in the oil well/gas well and/or flow line network facilitates dynamic reduction in:
the backpressure on the sandface; and
the backpressure in the flow line network, thereby facilitating extraction of the fluids, particularly natural gas.

Further, the reduction in the liquid holdup in the oil well/gas well and/or the flow line network facilitates in attaining a velocity more than the critical velocity of the fluids in the oil well/gas well. The velocity of the fluids more than the critical velocity is desired, so as to facilitate extraction of the fluids from the oil well/gas well.

Moreover, synergy or pressure balance is attained between the flow line network, the oil well/gas well, and the reservoir, on reduction in the liquid hold-up in the oil well/gas well and/or the flow line network, thereby:
improving the life of the oil well/gas well and the reservoir; and
facilitating extraction of the fluids from the reservoir via the oil well/gas well.

In accordance with the present disclosure, injecting the foaming composition in an amount lesser than the minimum amount of the foaming composition into the oil well/gas well and/or the flow line network results in an ineffective reduction in the liquid hold-up in the oil well/gas well and/or the flow line network, thereby ineffective in reducing the increasing backpressure due to increased liquid hold-up in the reservoir, the flow line network, and the oil well/gas well. Increase in the backpressure on the sandface, the reservoir and the flow line network of the oil well/gas well:
affects the synergy or pressure balance between the flow line network, the oil well/gas well and the reservoir; and
reduce the flow rate of the fluids below critical rate from the oil well/gas well, thereby ceasing the oil well/gas well.

Therefore, the injection of the optimum amount of the foaming composition into the oil well/gas well and/or the flow line network is desired, to extract the fluids from the reservoir via the oil well/gas well.

In accordance with the present disclosure, at least one corrosion inhibitor is injected or present in the oil well/gas and/or the flow line network before injecting the foaming composition.

In accordance with the present disclosure, the pure corrosion inhibitor is injected in an amount up to 0.005% (mass/mass) of the total liquid.

In accordance with the present disclosure, the corrosion inhibitor is at least one selected from the group consisting of 2-butoxyethanol, ethylene glycol and 2-mercaptoethyl alcohol.

In accordance with the present disclosure, the corrosion inhibitor is injected into the oil well/gas well and/or the flow line network to inhibit the corrosion in the oil well/gas well and/or the flow line network.

In accordance with the present disclosure, the composition includes injecting the de-foaming agent into the oil well/gas well and/or the flow line network.

In accordance with the present disclosure, the foaming composition is selected such that there exists a pre-determined balance between the foaming composition and the de-foaming agent based on the properties of the fluids, such as interfacial surface tension of the fluids.

The pre-determined balance, herein, refers to the balance between the amount of the foaming composition and the amount of de-foaming agent. Balanced amount of the foaming composition and the de-foaming agent injected into the oil well/gas well and/or the flow line network reduces the interfacial surface tension of the water and the natural gas, thereby facilitating extraction of the natural gas from the oil well/gas well.

Moreover, the amount of the foaming composition and the de-foaming agent injected into the oil well/gas well and/or the flow line network is dependent upon the amount of the water in the oil well/gas well and/or the flow line network.

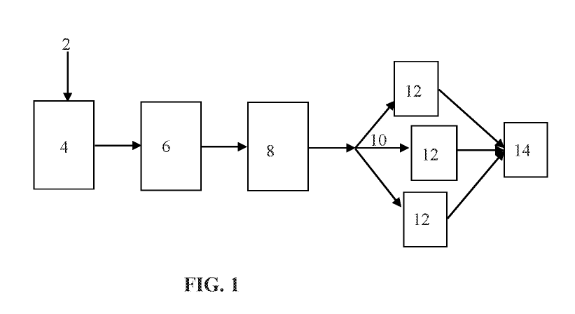

The system (depicted in FIG. 1) of the present disclosure comprises:
at least one manifold that is connected to and in communication with the oil well/gas well 12 via the flow line network 10;
at least one distribution assembly (4 and 6), typically umbilical distribution hub (UDH) 4 and subsea distribution assembly (SDA) 6, that is connected to and in communication with the manifold 8 for:
   transporting the extracted fluids from the oil well/gas well 12 to a surface facility 14; and
   transporting a composition, wherein the composition includes at least one of:
      the foaming composition 2; and
      the de-foaming agent,
   from the distribution assembly (4 and 6) to the oil well/gas well 12 and/or the flow line network 10; and
a plurality of control valves and sensors (not shown in FIG. 1) for monitoring pressure, temperature and flow rate of the fluids.

Typically, the foaming composition 2 (as shown in FIG. 1) is carried in the oil well/gas well 12 via the flow line network 10, the manifold 8 and the distribution assembly (4 and 6). The de-foaming agent is carried in the oil well/gas well 12 in the same way as that of the foaming composition 2.

In accordance with the present disclosure, the foaming composition includes:
ethylene glycol in an amount in the range of 10 to 30% (mass/mass) of the total liquid;
2-butoxyethanol in an amount in the range of 10 to 30% (mass/mass) of the total liquid;
isopropanol in an amount in the range of 1 to 5% (mass/mass) of the total liquid; and
quaternary ammonium compound in an amount in the range of 1 to 5% (mass/mass) of the total liquid.

In accordance with the present disclosure, the de-foaming agent is injected in an amount in the range of 0.1 to 0.2% (mass/mass) of the total liquid.

In accordance with the present disclosure, the de-foaming agent is preferably kerosene.

The present disclosure is further described in light of the following experiments which are set forth for illustration purpose only and not to be construed for limiting the scope of the disclosure. The following examples can be scaled up to industrial/commercial scale.

### Example-1: Effect of a Foaming Composition

Two oil wells/gas wells, namely B1 and B2, were drilled. With the continuous extraction of the natural gas from the wells, B1 and B2, the flow rate of the natural gas from the respective wells, B1 and B2, was decreased to 0.32 and 0.91 mmscd, respectively. Therefore, in order to increase the flow rate of the natural gas, a foaming composition comprising 30% ethylene glycol (mass/mass) of the total liquid, 30% 2-butoxyethanol (mass/mass) of the total liquid, 5% isopropanol (mass/mass) of the total liquid and 5% quaternary ammonium compound (mass/mass) of the total liquid was injected into the oil wells, B1 and B2.

Variation in the flow rates of the natural gas before and after injecting the foaming composition are tabulated in Table-1.

TABLE 1

| | Dosage of | Dosage of the | | |
|---|---|---|---|---|
| | the foaming | foaming | | Flow rate of |
| | composition | composition | Flow rate of | natural |
| S. | in B1 (10⁻³ m³/ | in B2 (10⁻³ m³/ | natural gas from | gas from |
| No | day) | day) | B1 (mmscd) | B2 (mmscd) |
| 1 | 0 | 0 | 0.32 | 0.91 |
| 2 | 160 | 500 | 0.54 | 0.98 |

Inference:

From the above table, it can be inferred that on injecting the foaming composition into the wells, B1 and B2, the flow rate of the natural gas from the respective wells, B1 and B2, increased as compared with the flow rate of the natural gas without injection of the foaming composition.

### Example-2: Effect of the Foaming Composition of Example-1 and a Corrosion Inhibitor (CI)

Two oil wells/gas wells, namely B3 and B4, were drilled. With the continuous extraction of the natural gas from the wells, B3 and B4, the flow rate of the natural gas from the respective wells, B3 and B4, was decreased to 0.39 and 0.93, respectively. Therefore, in order to increase the flow rate of the natural gas, the foaming composition of Example-1 and 2-butoxyethanol (CI) were injected into the oil wells, B3 and B4.

Variation in the flow rates of the natural gas before and after injecting the foaming composition and the CI are tabulated in Table-2.

TABLE 2

| | Dosage of | Dosage of | | | Flow rate | Flow rate |
|---|---|---|---|---|---|---|
| | the foaming | the foaming | Dosage of | Dosage of | of natural | of natural |
| | composition | composition | the CI in | the CI in | gas from | gas from |
| S. | in B3 (10⁻³ | in B4 (10⁻³ | B3 (10⁻³ | B4 (10⁻³ | B3 | B4 |
| No | m³/day) | m³/day) | m³/day) | m³/day) | (mmscd) | (mmscd) |
| 1 | 0 | 0 | 0 | 0 | 0.39 | 0.93 |
| 2 | 160 | 500 | 200 | 16.66 | 0.60 | 1.1 |

Inference:

From the above table, it can be inferred that on injecting the foaming composition of Example-1 and the CI into the wells, B3 and B4, the flow rate of the natural gas from the respective wells, B3 and B4, increased as compared with the flow rate of the natural gas:
after injecting the foaming composition (results tabulated in Table-1); and
without injecting the foaming composition and the CI.

### TECHNICAL ADVANCES AND ECONOMICAL SIGNIFICANCE

The present disclosure described herein above has several technical advantages including, but not limited to, the realization of a method and a system that:
decreases the liquid hold-up in the oil wells/gas wells and/or the flow line networks, thereby:
   decreasing the backpressure:
      on the sandface of the reservoir;
      in the oil wells/gas wells; and
      in the flow line networks; and
   facilitating in maintaining synergy (pressure balance) between the flow line networks, the oil wells and the reservoir, to extract fluids, particularly natural gas, from the reservoir via the oil wells/gas wells.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1) A method for extracting fluids comprising natural gas and water from a reservoir via at least one oil well/gas well connected to at least one flow line network, said method comprising:
a. injecting a composition containing a foaming composition in an amount in the range of 1% to 30% (mass/mass) of the total liquid at a pre-determined location into the at least one oil well/gas well and/or the at least one flow line network; and
b. allowing the natural gas to agitate said foaming composition and convert at least a portion of the water to foam, thereby reducing the interfacial surface tension between the natural gas and the water flowing through the oil well/gas well and/or the flow line network, and thereby facilitating reduction in liquid holdup in the at least one oil well/gas well and/or the at least one flow line network.

2) The method as claimed in claim 1, wherein said composition includes injecting a de-foaming agent in an amount in the range of 0.1 to 0.2% (mass/mass) of the total liquid, into the oil well/gas well and/or the flow line network.

3) The method as claimed in claim 2, wherein said de-foaming agent is kerosene.

4) The method as claimed in claim 1, wherein said foaming composition comprises:
ethylene glycol in an amount in the range of 10 to 30% (mass/mass) of the total liquid;
2-butoxyethanol in an amount in the range of 10 to 30% (mass/mass) of the total liquid;
isopropanol in an amount in the range of 1 to 5% (mass/mass) of the total liquid; and
quaternary ammonium compound in an amount in the range of 1 to 5% (mass/mass) of the total liquid.

5) A system for extracting fluids comprising natural gas and water from a reservoir via at least one oil well/gas well connected to at least one flow line network, said system comprising:
at least one manifold connected to and in communication with said at least one oil well/gas well via said at least one flow line network;
at least one distribution assembly connected to and in communication with said at least one manifold for:
transporting the extracted fluids from the at least one oil well/gas well to a surface facility; and
transporting at least one composition, wherein said composition comprising:
a foaming composition in the range of 1 to 30% (mass/mass) of the total liquid, wherein said foaming composition is injected at a pre-determined location into the oil well/gas well and/or the flow line network, and allowed to agitate by the natural gas and at least a portion of the water is converted to foam, thereby reducing the interfacial surface tension between the natural gas and the water flowing through the oil well/gas well and/or the flow line network, and thereby facilitating reduction in liquid holdup; and
a de-foaming agent in the range of 0.1 to 0.2% (mass/mass) of the total liquid,
from said at least one distribution assembly to said at least one oil well/gas well and/or said at least one flow line network; and
a plurality of control valves and sensors for monitoring pressure, temperature and flow rate of the fluid.
